(19) United States
(12) Patent Application Publication
(10) Pub. No.: US 2006/0154815 A1
(43) Pub. Date: Jul. 13, 2006

(54) Pelletized activated carbon and production method for the same

(75) Inventors: Susumu Abe, Okayama-ken (JP); Shizuo Ishimura, Okayama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kuraray Chemical Co., Ltd., Bizen-shi (JP)

(21) Appl. No.: 11/033,317

(22) Filed: Jan. 12, 2005

(51) Int. Cl. C01B 31/14

(52) U.S. Cl. 502/416; 23/314

(57) ABSTRACT

To provide useful general-purpose pelletized activated carbon and an industrially advantageous production method for pelletized activated carbon. The above-mentioned object is achieved by pelletized activated carbon that is pelletized by using, as binders, at least one kind of binder selected from a group (A group) consisting of acrylic emulsions and acryl-styrene-based emulsions and at least one kind of binder selected from a group (B group) consisting of cellulose ether and polyvinyl alcohol-based polymers, and a production method for the same.

### BACKGROUND OF THE INVENTION

1. Field of the Invention

The present invention relates to pelletized activated carbon and a production method for the same. The pelletized activated carbon of the invention is excellent in adsorptivity and hardness, so that it is preferably used for deodorization, solvent recovery, prevention of motor fuel transpiration, and catalyst in a vapor phase or liquid phase.

2. Description of the Prior Art

Recently, in order to effectively perform adsorbing operations, formed activated carbon in a form of pelletized activated carbon, a block, or a honeycomb has been used, and particularly, among these, in terms of cost, performance, and handling ease, pelletized activated carbon has been mainly used. Most of pelletized activated carbon is produced by so-called activation after pelletizing, wherein a carbonaceous material as a main material is added with a binder such as coal tar pitch, pulp spent liquor, blackstrap molasses or the like and pelletized, and then carbonized at several hundreds degrees C., and further activated in the atmosphere of an oxidized gas such as steam or carbon dioxide at high temperature 600 to 1100° C.

On the other hand, pelletized activated carbon pelletized by adding a binder to activated carbon, that is, pelletized activated carbon obtained by pelletization after activating is also generally known. For example, Japanese Published Examined Patent Application No. S48-7194 discloses a method for forming a block compact in which granular activated carbon with 4 to 40 meshes (4.75 to 0.420 mm) is mixed with oil-resistant staple fibers and filled into a container for adsorption, and these are bound integrally in a form of a millet cake by using a butadien-acrylonitrile-based, urethane-based, or styrene-butadien-based oil resistant emulsion type latex, and then dried to form a block compact.

Furthermore, Japanese Published Examined Patent Application No. H05-26747 discloses a production method in which powdery activated carbon obtained in advance by being activated is added with an inorganic binder such as bentonite white clay or water glass, pelletized, and fired at several hundreds degrees C., and Japanese Published Unexamined Patent Application No. H02-80315 discloses a pelletization method in which activated carbon activated by using meso-carbon microbeads that are optically anisotropic is pelletized by using at least one kind of a cellulose-based resin, a phenol resin, polyimide, bentonite, coal tar pitch, etc.

Furthermore, Japanese Published Unexamined Patent Application No. S52-108388 discloses a method for producing granulated activated carbon which is excellent in water resistance and has a high strength by pelletizing powdery activated carbon by using a water-soluble organic binder such as alginic acid or sodium salt of carboxymethylcellulose, etc., drying and curing it, and then substituting sodium with a bivalent or trivalent metal such as calcium, barium, copper, iron, or chromium.

However, the above-mentioned prior arts have the following problems. That is, pelletized activated carbon obtained by activation after pelletizing in which a carbonaceous material is carbonized and activated after being added with a binder and formed is easily cracked or powdered due to thermal distortion and activating contraction in the process of heating to a high temperature, and in particular, when it is attempted to obtain a highly activated high-performance product, these phenomena become conspicuous, so that it is difficult to realize both high adsorptivity and high hardness. Furthermore, adsorptivity and pore distribution are normally controlled by selection of the material and activating conditions, however, arbitrary adjustment of these is difficult.

The method disclosed in Japanese Published Examined Patent Application No. S48-7194 is effective for restraining vibration abrasion, however, it is difficult to apply this method to forming of normal pelletized activated carbon with a diameter of 2 to 6 mm like that of the invention, and use in bulk is difficult since the carbon is put in a container. Furthermore, the method does not increase the strength of each grain of pelletized activated carbon. Furthermore, it is mentioned that the oil resistant emulsion can be mixed with carboxymethylcellulose (CMC), however, necessity of mixing with CMC is not mentioned at all, and the strength improvement effect is not clearly mentioned.

Japanese Published Examined Patent Application No. H05-26747 discloses a method using an inorganic binder such as bentonite as a method for forming after activating, and this is advantageous in that activated carbon to be used as a base can be comparatively freely selected, however, not only inorganic impurities as an ash content increase but also the bulk density becomes higher than necessary, and further high-temperature treatment at approximately 600° C. or higher becomes necessary.

In the method disclosed in Japanese Published Unexamined Patent Application No. H02-80315, the cost is originally high since meso-carbon microbeads are formed into pelletized activated carbon by refining pitch, and addition of a reaction accelerator or activation by using alkali such as KOH is required since the reaction rate with an oxidized gas is low, and these increase the cost higher than normal oxidized gas activation. Furthermore, in the method disclosed in Japanese Published Unexamined Patent Application No. S52-108388, a sodium salt such as alginic acid is used as a binder and is substituted with a bivalent or trivalent metal in a post-process, so that the procedures are complicated and inevitably increase the cost. Therefore, an object of the invention is to provide general-purpose pelletized activated carbon excellent in adsorptivity and hardness and an industrially advantageous production method for pelletized activated carbon.

### SUMMARY OF THE INVENTION

The inventors focused on the fact that selection of properties of activated carbon and a binder were important for achieving the above-mentioned object, and arrived at the invention through earnest examination. Namely, the invention provides pelletized activated carbon pelletized by adding a binder to powdery or granular activated carbon, where at least one kind of binder selected from a group (A group) consisting of acrylic emulsions and acryl-styrene-based emulsions and at least one kind of binder selected from a group (B group) consisting of cellulose ether and polyvinyl alcohol-based polymers are used as the binder.

Furthermore, another aspect of the invention provides a production method for pelletized activated carbon wherein at least one kind of binder selected from a group (A group) consisting of acrylic emulsions and acryl-styrene-based emulsions and at least one kind of binder selected from a group (B group) consisting of cellulose ether and polyvinyl alcohol-based polymers are added to powdery or granular activated carbon, kneaded, and pelletized, and the obtained pelletized activated carbon is dried at 200° C. or lower and cured, and then cooled to room temperature.

The invention provides pelletized activated carbon that can be widely used for various purposes and an industrially advantageous production method for pelletized activated carbon. The pelletized activated carbon of the invention has high strength as well as excellent adsorptivity, so that fine powder is hardly produced during transportation or use, and the pelletized activated carbon of the invention can be used for a purpose which involves vibration and impact applied and cannot use conventional pelletized activated carbon, and therefore, it can be preferably used in a vapor phase or liquid phase. Furthermore, by blending a plurality of kinds of activated carbons, the pore distribution and the adsorptivity can be arbitrarily controlled, so that pelletized activated carbon can be produced which is applicable to a variety of uses not only for adsorbing removal of mono chemical compositions such as nitrogen, methane, butane, toluene, etc., but also for deodorization, solvent recovery, prevention of motor fuel transpiration, catalyst and so on.

### BRIEF DESCRIPTION OF THE DRAWINGS

FIG. 1 is a conceptual diagram of a canister.

FIG. 2 is a pore distribution diagram of a coconut shell activated carbon and coal-based activated carbon.

FIG. 3 is a pore distribution diagram of pelletized activated carbons of Examples 24 through 26.

### DESCRIPTION OF THE PREFERRED EMBODIMENTS

A carbonaceous material as a raw material of the activated carbon used in the invention is not especially limited as long as it is formed into activated carbon by being activated, and can be selected from various isotropic carbonaceous materials of plant-based materials, mineral-based materials, natural materials, and synthetic materials. Concretely, as plant-based carbonaceous materials, wood, sawdust, charcoal, nut shells such as coconut shells and walnut shells, and fruit seeds, etc., are available, as mineral-based carbonaceous materials, coals such as peat, lignite, brown coal, bituminous coal, and anthracite, etc., petroleum-based and/or coal-based pitch, coke, tars such as coal tar and petroleum tar, petroleum distillation residue, etc., are available, and as natural materials, natural fibers such as cotton and hemp, regenerated fibers such as rayon and viscose rayon, semisynthetic fibers such as acetate and triacetate are available, and as synthetic materials, polyamide-based materials such as nylon, polyvinyl alcohol-based materials such as vinylon, polyacrylonitril-based materials such as acryl, polyolefin-based materials such as polyethylene and polypropylene, polyurethane, phenol-based resins, polyvinyl alcohol (abbreviated to PVA), polyvinyl chloride-based resins, vinylidene chloride, ion-exchange resins or carbides thereof are available.

In the invention, use of activated carbon obtained by blending at least two kinds with different pore distributions as the powdery or granular activated carbon is preferable since production of pelletized activated carbon with an arbitrary pore diameter distribution becomes easy and the adsorptivity can be controlled.

Furthermore, in the invention, as the powdery or granular activated carbon, use of activated carbon obtained by blending at least one kind selected among coal, petroleum-based coke, coal ash, and clay with the powdery or granular activated carbon is preferable for controlling the bulk density and adsorptivity.

The form of the carbonaceous material is not limited, and various forms such as powder, grains, fibers, and sheets can be used, however the grain size of 0.3 mm or less of the powdery or granular activated carbon is suitable for pelletization and preferable.

It is desirable that pelletized activated carbon is excellent not only in mechanical strength against abrasion and pressures in filling into and removal from an adsorbing tower and adsorbing operations but also in water resistance and oil resistance, and the greatest characteristic of the invention is in that pelletized activated carbon is produced by selecting a binder to be added for achieving this object. As the binder, at least one kind selected from a group (A group) consisting of acrylic emulsions and acryl-styrene-based emulsions and at least one kind selected from a group (B group) consisting of cellulose ether and PVA-based polymers are used.

Among the A-group binders, as acrylic-based emulsions, for example, trade names RX-866A and RX-878A, etc., made by Nippon Carbide Industries Co., Inc. can be used, and as acryl-styrene-based emulsions, for example, trade names RX-383B and RX-832A, etc., made by Nippon Carbide Industries Co., Inc. can be used. Among the acrylic emulsions, acryl copolymer-based emulsions are preferable, and as such emulsions, for example, trade names FX-619 and FX-6074 made by Nippon Carbide Industries Co., Inc., can be used.

As B-group binders, cellulose ether and PVA-based polymers are available. As detailed examples of cellulose ether, for example, methylcellulose, ethylcellulose, substitutions and derivatives of these, carboxyalkylcellulose such as carboxymethylcellulose, carboxyethylcellulose, and carboxymethylethylcellulose, sodium salts and ammonium salts of these are available. Furthermore, as PVA-based polymers, for example, PVA, denatured PVA, etc., are available. It is preferable that the B-group binders are used in the form of solutions, and therefore, water-soluble materials are desirable.

Particularly, as a binder, a binder made of an acryl copolymer-based emulsion and carboxymethylcellulose is preferably used. This combination provides a hardness higher than in the case where the same blending amount of another binder is used.

The form of pelletized activated carbon is not especially limited, however, in terms of production ease and handling ease, a columnar shape is preferable. The diameter of the column is preferably 0.6 to 12 mm, and the ratio of the height to diameter is preferably 1 through 10. More preferably, diameter of the column is 1 to 5 mm, and the ratio of the height to diameter is 2 through 3.

The hardness of the pelletized activated carbon is preferably 10% or more, more preferably, 15% or more, and still more preferably, 30% or more. The hardness of the pelletized activated carbon of the invention is micro strength hardness (MS hardness) obtained by a coke strength test method. The MS hardness is obtained by applying a one coke strength test method to pelletized activated carbon, and describing simply, a 5 g sample and 10 steel balls with a diameter of 8 mm are placed into an iron-made container with a diameter of 1 inch and a length of 12 inches and rotated 1000 turns at 25 rpm, and then a weight staying on a standard sieve with 0.3 mm meshes is expressed in percent. Next, a production method for the pelletized activated carbon of the invention is described.

At least one kind of binder selected from a group (A group) consisting of acrylic emulsions and acryl-styrene-based emulsions and a binder made of at least one kind of solution selected from a group (B group) consisting of cellulose ether such as methylcellulose, ethylcellulose, carboxymethylcellulose, etc., and PVA-based polymers such as PVA as mentioned above, are added to powdery or granular activated carbon, kneaded, pelletized, and then dried at 200° C. or lower, cured, and cooled to room temperature, whereby the pelletized activated carbon of the invention is produced.

As the amounts of the binders to be added, to 100 parts by weight of activated carbon, as solid contents, 2 to 40 parts by weight of the A group and 0.5 to 10 parts by weight of the B group are preferably added, and 10 to 20 parts by weight of the A group and 2 to 4 parts by weight of the B group are more preferably added. To produce the pelletized activated carbon, first, the binders are added to powdery or granular activated carbon, and then kneaded by a kneader, etc. The mixture is then pelletized by a pelletizing machine such as a pelleter, dried at a temperature of 200° C. or lower, cured, and cooled to the room temperature, whereby the pelletized activated carbon is produced.

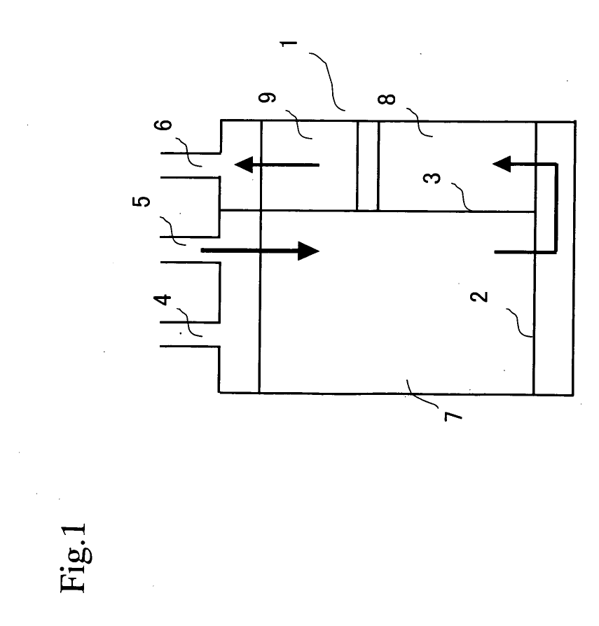

The pelletized activated carbon of the invention can be used for various purposes of deodorization, solvent recovery, prevention of motor fuel transpiration, and catalyst, and in particular, it is preferably used for prevention of motor fuel transpiration. FIG. 1 is a conceptual diagram of a canister to be used for preventing motor fuel transpiration. In terms of the effect for preventing motor fuel transpiration, it is preferable that the pelletized activated carbon of the invention is used for a vent-side section joined to a section made of activated carbon in a granular form or the like excellent in adsorptivity connected to a fuel tank system.

In FIG. 1, the reference number 1 denotes a canister, 2 denotes a breathable supporting body, 3 denotes a separation wall, 4 denotes a purge connector, 5 denotes a fuel tank side connector, 6 denotes a vent hole, 7 denotes a section filled with granular activated carbon excellent in adsorptivity for high-concentration gasoline, 8 and 9 denote sections filled with the pelletized activated carbon of the invention excellent in adsorptivity for low-concentration gasoline. The arrows show the flowing directions of transpirable fuel in a case where the transpirable fuel is adsorbed when the vehicle stops, and when it is desorbed, the adsorbed transpirable fuel is burned by an engine through a reversed route.

The adsorptivity of the pelletized activated carbon of the invention can be confirmed by measuring the benzene adsorptivity. The benzene adsorptivity can be measured according to the measurement of solvent vapor adsorptivity of JIS K1474, and is expressed in equilibrium adsorption at a concentration 1/10 of the saturated concentration. The central pore radius of the pelletized activated carbon was calculated from a pore distribution curve obtained by a vapor adsorption method. In the pelletized activated carbon of the invention, lowering in benzene adsorptivity due to pelletization is slight, and adsorptivity of 70 through 90% can be obtained with respect to the activated carbon raw material. Hereinafter, the invention is described in detail on the basis of examples, however, the invention is not limited to these. The mixing ratios in the examples and comparative examples are all expressed in parts by weight.

### EXAMPLES 1 THROUGH 10 AND COMPARATIVE EXAMPLES 1 AND 2

Coal-based powdery activated carbon (KG-DH made by Kuraray Chemical Co., Ltd.) having a benzene adsorptivity of 50%, a specific surface area of 1400 m²/g, and in a pore distribution obtained by a vapor adsorption method, a central pore diameter of 30 Å, and a grain size of 0.1 mm or less was mixed with carboxymethylcellulose (abbreviated to CMC) WSC made by Dai-Ichi Kogyo Seiyaku Co., Ltd. as a B-group binder by a mixing ratio fixed to 3 parts by weight and an acryl-styrene-based emulsion RX-383B (abbreviated to ASE) made by Nippon Carbide Industries Co., Inc. as an A-group binder by mixing ratios changed among 3 through 30, kneaded, and pelletized, and pelletized activated carbons thus obtained were dried at 130° C. and cured, and then cooled to room temperature, and the benzene adsorptivity and MS hardness of the produced pelletized activated carbons were measured (Examples 1 through 5). Furthermore, the benzene adsorptivity and MS hardness when A-group binder was fixed to 10 parts by weight of ASE and the CMC amount as a B-group binder was changed among 1 through 5 parts by weight were measured (Examples 6 and 7). The sizes of the pelletized activated carbons were adjusted by changing the dies pore diameter. The effects of the pelletized activated carbon sizes are shown in Examples 8 and 9.

By using the A-group binder and the B-group binder separately from each other, pelletized activated carbons were produced, and the benzene adsorption and MS hardness were measured in the same manner (Comparative examples 1 and 2). Furthermore, the measurement was made in the case where the CMC amount was fixed to 3 parts by weight and the ASE amount was reduced, and the results of the measurement are shown in Example 10.

TABLE 1

| | | Mixing ratio | | | | | |
|---|---|---|---|---|---|---|---|
| | | (parts by weight) | | | Benzene | | |
| | Pelletized | | (A) ASE | (B) CMC | adsorptivity | | |
| | activated carbon | Activated | Solid | Solid | Adsorption | Ratio to raw | |
| | diameter (mm) | carbon | content | content | amount (%) | material (%) | MS hardness (%) |
| Example 1 | 3.0 | 100 | 3 | 3.0 | 46.2 | 92.3 | 16.5 |
| Example 2 | 3.0 | 100 | 5 | 3.0 | 45.1 | 90.1 | 32.2 |
| Example 3 | 3.0 | 100 | 10 | 3.0 | 43.3 | 86.5 | 76.3 |
| Example 4 | 3.0 | 100 | 20 | 3.0 | 39.4 | 78.8 | 83.7 |
| Example 5 | 3.0 | 100 | 30 | 3.0 | 36.1 | 72.1 | 85.1 |
| Example 6 | 3.0 | 100 | 10 | 1.0 | 44.2 | 88.3 | 50.5 |
| Example 7 | 3.0 | 100 | 10 | 5.0 | 42.3 | 84.6 | 79.6 |
| Example 8 | 4.0 | 100 | 10 | 3.0 | 43.3 | 86.6 | 75.5 |
| Example 9 | 2.0 | 100 | 10 | 3.0 | 42.5 | 84.9 | 77.3 |
| Example 10 | 3.0 | 100 | 1 | 3.0 | 47.1 | 94.1 | 10.6 |
| Comparative | 3.0 | 100 | 0 | 3.0 | 47.8 | 95.6 | 0.0 |
| example 1 | | | | | | | |
| Comparative | 3.0 | 100 | 3 | 0.0 | 46.7 | 93.3 | 8.8 |
| example 2 | | | | | | | |

### EXAMPLE 11

Pelletized activated carbon was produced in the same manner as in Example 5 except that hydroxyethylcellulose HEC-SP900 made by Daicel Chemical Industries, Ltd. was used as the B-group binder. The benzene adsorption amount of the pelletized activated carbon was 33.6%, the ratio to the raw material was 67.2%, and the MS hardness was 86.0%.

### EXAMPLES 12 THROUGH 15

Pelletized activated carbons were produced by fixing the B-group binder to 3 parts by weight of CMC and changing the A-group binder to an acrylic emulsion RX-878A (abbreviated to AE) made by Nippon Carbide Industries Co., Inc., and the benzene adsorptivity and MS hardness were measured. The results of measurement are shown in Table 2.

TABLE 2

| | | Mixing ratio | | | | | |
|---|---|---|---|---|---|---|---|
| | | (parts by weight) | | | Benzene | | |
| | Pelletized | | (A) AE | (B) CMC | adsorptivity | | |
| | activated carbon | Activated | Solid | Solid | Adsorption | Ratio to raw | |
| | diameter (mm) | carbon | content | content | amount (%) | material (%) | MS hardness (%) |
| Example 12 | 3.0 | 100 | 5 | 3.0 | 45.2 | 90.3 | 30.0 |
| Example 13 | 4.0 | 100 | 10 | 3.0 | 43.6 | 87.1 | 82.7 |
| Example 14 | 3.0 | 100 | 20 | 3.0 | 38.4 | 76.8 | 81.7 |
| Example 15 | 2.0 | 100 | 30 | 3.0 | 35.3 | 70.6 | 76.3 |

### EXAMPLES 16 THROUGH 19

Pelletized activated carbons were produced by fixing the B-group binder to 3 parts by weight of CMC and changing the A-group binder to an acrylic copolymer-based emulsion FX-6074 (abbreviated to AC) made by Nippon Carbide Industries Co., Inc., and the benzene adsorptivity and MS hardness were measured. The results of measurement are shown in Table 3.

TABLE 3

| | | Mixing ratio | | | | | |
|---|---|---|---|---|---|---|---|
| | | (parts) | | | Benzene | | |
| | Pelletized | | (A) ASE | (B) PVA | adsorptivity | | |
| | activated carbon | Activated | Solid | Solid | Adsorption | Ratio to raw | |
| | diameter (mm) | carbon | content | content | amount(%) | material(%) | MS hardness (%) |
| Example 16 | 3.0 | 100 | 5 | 3.0 | 45.7 | 91.4 | 32.6 |
| Example 17 | 4.0 | 100 | 10 | 3.0 | 42.9 | 85.8 | 85.5 |
| Example 18 | 5.0 | 100 | 20 | 3.0 | 38.5 | 77.0 | 93.2 |
| Example 19 | 3.0 | 100 | 30 | 3.0 | 36.3 | 72.6 | 86.6 |

### EXAMPLES 20 THROUGH 23

Pelletized activated carbons were produced by fixing the A-group binder to 10 parts by weight of ASE and changing the B-group binder to PVA 217 made by Kuraray Co., Ltd., and the benzene adsorptivity and MS hardness were measured. The results of measurement are shown in Table 4.

TABLE 4

| | | Mixing ratio | | | | | |
|---|---|---|---|---|---|---|---|
| | | (parts) | | | Benzene | | |
| | Pelletized | | (A) ASE | (B) PVA | adsorptivity | | |
| | activated carbon | Activated | Solid | Solid | Adsorption | Ratio to raw | |
| | diameter (mm) | carbon | content | content | amount(%) | material(%) | MS hardness (%) |
| Example 20 | 4.0 | 100 | 10 | 6.6 | 41.8 | 83.5 | 81.9 |
| Example 21 | 3.0 | 100 | 10 | 5.4 | 41.7 | 83.4 | 78.6 |
| Example 22 | 2.0 | 100 | 10 | 4.2 | 42.7 | 85.3 | 66.0 |
| Example 23 | 3.0 | 100 | 10 | 1.8 | 44.0 | 88.0 | 59.5 |

### COMPARATIVE EXAMPLES 3 THROUGH 5

Pelletized activated carbons were produced by fixing the B-group binder to 3 parts by weight of CMC and adding 8 through 42 parts by weight of a phenol resin emulsion PR-51464 made by Sumitomo Durez Co., Ltd. as an A-group binder, and the benzene adsorptivity and MS hardness were measured. The results of measurement are shown in Table 5.

TABLE 5

| | | Mixing ratio | | | | | |
|---|---|---|---|---|---|---|---|
| | | (parts) | | | | | |
| | | | (A) | | | | |
| | | | Phenol | | Benzene | | |
| | | | resin | (B) CMC | adsorptivity | | |
| | Pelletized activated | Activated | Solid | Solid | Adsorption | Ratio to raw | |
| | carbon diameter (mm) | carbon | content | content | amount(%) | material(%) | MS hardness (%) |
| Comparative | 3.0 | 100 | 8 | 3.0 | 43.6 | 87.1 | 1.4 |
| example 3 | | | | | | | |
| Comparative | 3.0 | 100 | 16 | 3.0 | 40.6 | 81.1 | 6.5 |
| example 4 | | | | | | | |
| Comparative | 2.0 | 100 | 32 | 3.0 | 34.2 | 68.4 | 8.9 |
| example 5 | | | | | | | |

### COMPARATIVE EXAMPLES 6 THROUGH 7

Pelletized activated carbons were produced by using bentonite as a binder, and the benzene adsorptivity and MS hardness were measured. The results of measurement are shown in Table 6.

TABLE 6

| | | Mixing ratio | | | | | |
|---|---|---|---|---|---|---|---|
| | | (parts) | | Heat | Benzene | | |
| | | | Bentonite | treatment | adsorptivity | | |
| | Pelletized activated | Activated | Solid | temperature | Adsorption | Ratio to raw | |
| | carbon diameter (mm) | carbon | content | ° C. | amount(%) | material(%) | MS hardness (%) |
| Comparative | 3.0 | 100 | 30 | 800 | 34.7 | 73.4 | 0.6 |
| example 6 | | | | | | | |
| Comparative | 2.0 | 100 | 40 | 800 | 27.0 | 54.0 | 12.8 |
| example 7 | | | | | | | |

### EXAMPLES 24 THROUGH 26 AND COMPARATIVE EXAMPLES 8 AND 9

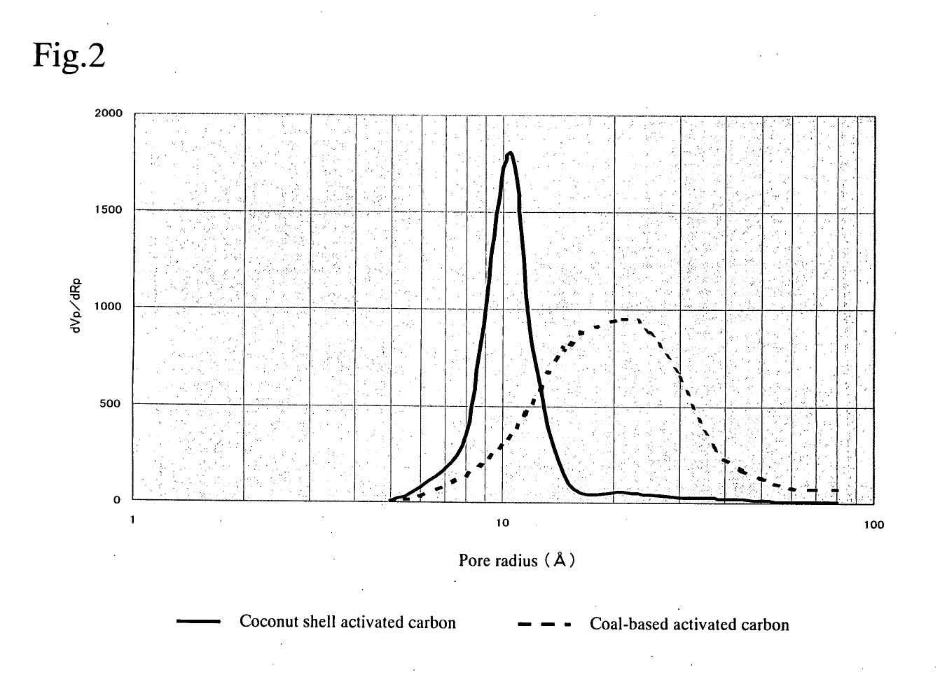

FIG. 2 shows pore distributions of coconut shell activated carbon having fine pores measured by a vapor adsorption method and coal-based activated carbon having large pores. These two kinds of activated carbons with different pore distributions were blended by a weight ratio of 1 to 1, and used to produce pelletized activated carbon in the same manner as in Example 3 (Example 24).

Furthermore, in place of the coconut shell activated carbon, a blend of coal coke and coal-based activated carbon by a weight ratio of 4 to 6 and a blend of coal ash and coal-based activated carbon by a weight ratio of 6 to 4 were used to produce pelletized activated carbons (Examples 25 and 26). Comparative examples 8 and 9 are obtained by changing the blending ratios of the binders. The results are shown in Table 7.

TABLE 7

| | | Mixing ratio (parts by weight) | | | | | | | |
|---|---|---|---|---|---|---|---|---|---|
| | Pelletized | Coconut | | | | (A) | (B) | | |
| | activated | shell | | | | AC | CMC | | |
| | carbon | activated | Coal-based activated | Coal | | Solid | Solid | Benzene | MS |
| | diameter (mm) | carbon | carbon | coke | Coal ash | content | content | adsorptivity (%) | hardness (%) |
| Example 24 | 4.0 | 50 | 50 | 0 | 0 | 10 | 3.0 | 42.1 | 80.5 |
| Example 25 | 2.5 | 0 | 60 | 40 | 0 | 10 | 2.5 | 25.6 | 70.2 |
| Example 26 | 3.0 | 0 | 40 | 0 | 60 | 20 | 2.0 | 16.0 | 82.7 |
| Comparative | 2.0 | 50 | 50 | 0 | 0 | 0 | 3.0 | 46.6 | 7.8 |
| example 8 | | | | | | | | | |
| Comparative | 3.0 | 0 | 50 | 0 | 50 | 1 | 2.0 | 25.0 | 9.0 |
| example 9 | | | | | | | | | |

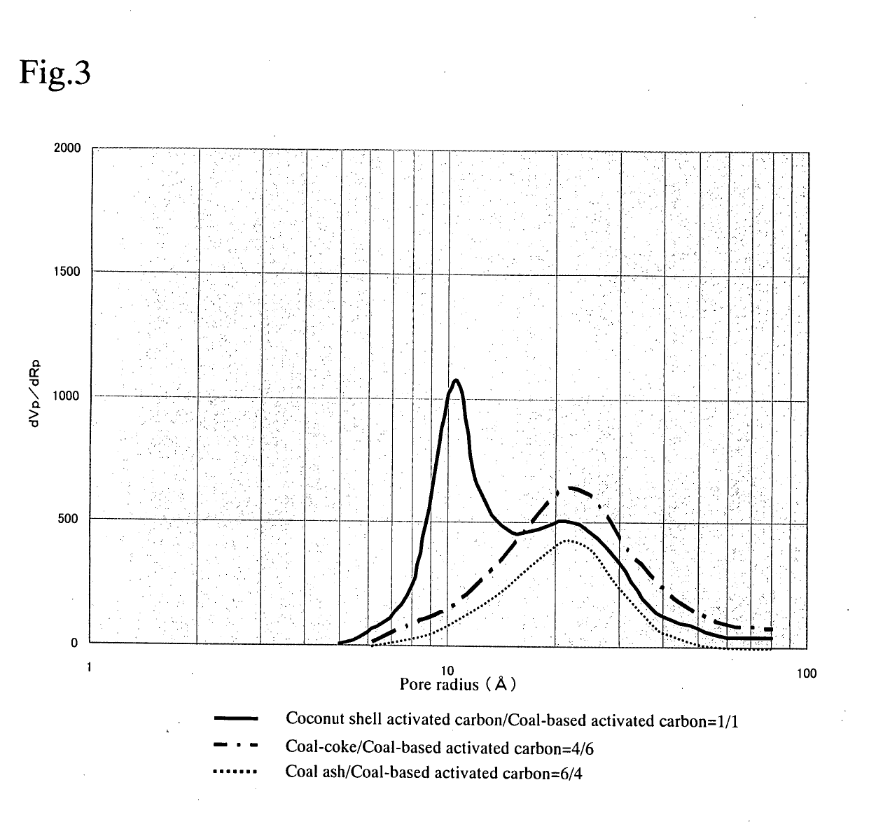

Pore distribution curves of these pelletized activated carbons are shown in FIG. 3. Thus, by blending two kinds of activated carbons having different pore distributions or properly blending coke with a different adsorptivity, pelletized activated carbon having a desired pore distribution and adsorptivity can be obtained easily.

### EXAMPLE 27

Pelletized activated carbon was produced in the same manner as in Example 26 except that Kaolin clay made by Hujilight Industrial Co., Ltd. was used in place of coal ash. The benzene adsorption amount of the pelletized activated carbon was 16.2%, the MS hardness was 83.4%. The pore distribution curve was almost the same as in the case of coal ash (illustration omitted).

### EXAMPLES 28 THROUGH 29 AND COMPARATIVE EXAMPLE 10

Coal-based granular activated carbon having a butane working capacity (abbreviated to BWC) of 12 g/dL (deciliters) measured by ASTM D5228 as a typical performance evaluation method for motor fuel transpiration preventive activated carbon and a bulk density of 0.40 g/mL (milliliters) was pulverized into a grain size of 0.1 mm or less to produce pelletized activated carbons under conditions of Examples 3 and 13, and then BWC was measured (Examples 28 and 29). For comparison, the BWC of the original coal-based activated carbon was measured and the results of measurement are also shown as Comparative example 10. The results of measurement are shown in Table 8.

2200 mL of activated carbon 3GX made by Kuraray Chemical Co., Ltd. (bulk density: 0.34 g/mL, BWC 15.1 g/dL (ASTM, D5228-92)) was used as the activated carbon of the reference number 7 in FIG. 1, and 500 ml of activated carbon 2GK made by Kuraray Chemical Co., Ltd. (bulk density: 0.36 g/mL, BWC 11.8 g/dL (ASTM, D5228-92)) was used as activated carbon of reference number 8 in FIG. 1, and pelletized activated carbons obtained by Examples 28 and 29 were filled by 300 ml into section 9 of FIG. 1 and a DBL test was conducted. In addition, the pelletized activated carbon of Comparative example 10 was used for the section 9 and a DBL test was conducted in the same manner.

The DBL test method was carried out on the basis of “Impact and Control of Canister Bleed Emissions,” R. S. Williams and C. R. Clontz, Technical Paper 2001-01-0733. The results of this test are shown in Table 8.

TABLE 8

| | | Mixing ratio | | | | | | | |
|---|---|---|---|---|---|---|---|---|---|
| | Pelletized | Coal- | | | | | | | |
| | activated | based | | (A) | (B) CMC | Bulk | | | |
| | carbon | activated | Coal | Solid | Solid | density | | MS | |
| | diameter (mm) | carbon | coke | content | content | (g/mL) | BWC (g/dL) | hardness (%) | DBL (mg) |
| Example 28 | 2.0 | 70 | 30 | (AC)10 | 3.0 | 0.450 | 9.4 | 65.5 | 34 |
| Example 29 | 3.0 | 60 | 40 | (AE)20 | 3.0 | 0.466 | 8.0 | 82.6 | 28 |
| Comparative | 2.2 | — | — | — | — | 0.380 | 12.5 | 53.8 | 86 |
| example 10 | | | | | | | | | |

What is claimed is:

1. A pelletized activated carbon comprising a powdered or a granular activated carbon, at least one binder selected from a group A binder and at least one binder selected from a group B binder wherein, the group A binder is selected from the group consisting acrylic emulsions, acryl-styrene-based emulsions and mixtures thereof and the group B binder is selected from the group consisting of cellulose ether, polyvinyl alcohol-based polymers and mixtures thereof.

2. The pelletized activated carbon according to claim 1, wherein the powdered or the granular activated carbon is a blend of activated carbon with at least two different pore distributions.

3. The pelletized activated carbon according to claim 1, wherein the powdered or the granular activated carbon is selected from the group consisting of coal, petroleum-based coke, coal ash and mixtures thereof.

4. The pelletized activated carbon according to claim 3 further comprising clay.

5. The pelletized activated carbon according to claim 1, wherein the grain size of the powdered or the granular activated carbon is 0.3 mm or less.

6. The pelletized activated carbon according to claim 1, wherein the group A binder is an acryl copolymer-based emulsion and the group B binder is a carboxymethylcellulose.

7. The pelletized activated carbon according to claim 1, wherein the pelletized activated carbon is columnar.

8. The pelletized activated carbon according to claim 6, wherein the diameter of the columnar shape is 0.6 to 12 mm, and the ratio of the height to diameter is 1 through 10.

9. The pelletized activated carbon according to claim 1, wherein the hardness of the pelletized activated carbon is 10% or more.

10. A method for producing the pelletized activated carbon as claimed in claim 1 comprising:
1) mixing the powdered or the granular activated carbon with at least one binder from the group A binder and at least one binder from the group B binder to form a mixture,
2) kneading the mixture,
3) pelletizing the mixture,
4) drying and curing the mixture at 200° C. or lower, and
5) cooling the mixture to room temperature.

11. The method for producing the pelletized activated carbon as claimed in claim 10, wherein the binder adding amounts are 2 to 40 parts by weight of the group A binder as a solid content and 0.5 to 10 parts by weight of the group B binder as a solid content with respect to 100 parts by weight of activated carbon.

12. The method for producing the pelletized activated carbon as claimed in claim 10, wherein the group A binder is an acryl copolymer-based emulsion and the group B binder is a carboxymethylcellulose.

13. The method for producing the pelletized activated carbon as claimed in claim 10, wherein the powdered or the granular activated carbon is a blend of activated carbon with at least two different in pore distributions.

14. The method for producing the pelletized activated carbon as claimed in claim 10, wherein the powdered or the granular activated carbon is selected from the group consisting of coal, petroleum-based coke, coal ash and mixtures thereof.

15. The method for producing the pelletized activated carbon as claimed in claim 10 wherein clay is additionally added in Step 1) to form the mixture.
